(19) United States
(12) Patent Application Publication
(10) Pub. No.: US 2013/0294616 A1
(43) Pub. Date: Nov. 7, 2013

(54) METHOD AND SYSTEM FOR SPEECH ENHANCEMENT IN A ROOM

(71) Applicant: Hans Mülder, Wunnewil (CH)

(72) Inventor: Hans Mülder, Wunnewil (CH)

(73) Assignee: PHONAK AG, Staefa (CH)

(21) Appl. No.: 13/995,574

(22) PCT Filed: Dec. 20, 2010
(86) PCT No.: PCT/EP2010/070282

§ 371 Date: Jul. 25, 2013

(51) Int. Cl. G10L 21/0208

(52) U.S. Cl. CPC G10L 21/0208
USPC 381/71.1

(57) ABSTRACT

A system for speech enhancement in a room, having: a microphone arrangement with at least two spaced apart microphones for capturing audio signals from a speaker's voice, an acoustic beamforming unit for processing the captured audio signals in a manner so as to impart one of a plurality of different directional patterns to the microphone arrangement; a feedback cancellation unit for applying a feedback cancellation algorithm to the processed audio signals and for providing a feedback status signal indicating how close an acoustic feedback loop of the system is to feedback; an amplifier for amplifying the processed audio signals; a loudspeaker arrangement to be located in the room for generating sound according to the amplified audio signals; and a control for selecting the directional pattern imparted to the microphone arrangement as a function of the feedback status signal.

### BACKGROUND OF THE INVENTION

1. Field of the Invention

The present invention relates to a system for speech enhancement in a room comprising a microphone arrangement comprising at least two spaced-apart microphones for capturing audio signals from a speaker's voice, an acoustic beamformer unit for processing the captured audio signals in a manner so as to impart a directional pattern to the microphone arrangement, a feedback cancellation unit for applying a feedback cancellation algorithm to the processed audio signals, means for amplifying the processed audio signals and a loudspeaker arrangement located in the room for generating sound according to the amplified audio signals.

2. Description of Related Art

Such a system is described above is known, for example, from International Patent Application Publication WO 2010/000878 A2 and corresponding U.S. Patent Application Publication 2012/0221329 A1.

U.S. Pat. No. 7,054,451 B2 relates to a speech enhancement system, wherein the microphones are provided with a microphone beamformer and a plurality of loudspeakers is provided with an adaptive loudspeaker beamformer, wherein the latter is able to create a beam pattern which is capable of creating a null in the direction of the speaker(s) using the microphones in order to prevent feedback noise.

U.S. Pat. No. 4,489,442 relates to a speech enhancement system comprising a plurality of microphone arrays, each comprising a unidirectional front microphone and an unidirectional rear microphone, which both have a cardioid sensitivity pattern and which are arranged at opposite ends of the array. The microphones also may have other sensitivity patterns such as bidirectional or omni-directional. The system works as a voice activity detector, wherein that microphone array which receives speech is activated, while the other microphone arrays are deactivated.

U.S. Pat. No. 8,238,547 B2 relates to a speech enhancement system comprising a plurality of directional microphones and a signal processing block including an echo cancellation unit.

Hearing aids comprising acoustic beamforming are described, for example, in U.S. Pat. Nos. 5,473,701 and 6,522,756, European Patent Applications EP 1 005 783 B1, EP 1 391 138 B1 (which corresponds to International Patent Application Publication WO 01/60112), and EP 1 320 281 A1 and International Patent Application Publication WO 00/68703 A2 and corresponding U.S. Pat. No. 6,449,216.

Feedback noise is a major problem in speech enhancement systems, especially when a lapel microphone is used. Feedback limits the gain that can be applied and/or it limits the mobility of the user of the lapel microphone (which may be wireless); also, feedback may cause loud unpleasant whistling. It is known that feedback problems can be reduced, to some extent, by applying a feedback cancellation algorithm in the feedback loop and by the use of directional microphones.

### SUMMARY OF THE INVENTION

It is an object of the invention to provide for a speech enhancement system in a room, wherein feedback should be reduced while achieving a high signal-to-noise ratio. It is also an object of the invention to provide for a corresponding speed enhancement method.

According to the invention, these objects are achieved by a system and by a method as described herein.

The invention is beneficial in that, by selecting the directional pattern imparted by the beamforming unit to the microphone arrangement as a function of a feedback status signal which is provided by the feedback cancellation unit and which indicates how close the system is to an acoustic feedback condition, the signal-to-noise ratio may be optimized at low gain conditions, e.g., when the system is sufficiently far away from feedback, for example, by selecting a directional pattern which is optimized for capturing speech from the mouth of the speaker, while the sensitivity of the system to feedback can be reduced at high gain conditions, i.e. when the system is close to feedback, by selecting, for example, a directional pattern which has low sensitivity in the direction of the loudspeaker arrangement.

The system is particularly useful for a lapel microphone arrangement, since lapel microphones are particularly prone to feedback.

The directional pattern selected at low gain conditions may be a cardioid pattern while the directional pattern selected at high gain conditions close to the feedback may be a bidirectional pattern. A cardioid pattern, with the highest sensitivity facing upwards towards the mouth of the speaker and the lowest sensitivity facing downwards, has the advantage that head movements to the left and to the right do not deteriorate the level of the sound picked up by the microphone arrangement too much. The bidirectional pattern has the advantage that it has a reduced sensitivity, compared to the cardioid pattern, in a horizontal plane; this is particularly useful if the microphone arrangement is in the near field of the loudspeaker arrangement, where most of the sound energy is propagating in a horizontal direction which will be the case if a loudspeaker arrangement is a line array positioned in an upright position at the height of the talker's mouth. However, the bidirectional pattern is more susceptible to changes in the level of the sound picked up by the microphone arrangement in case of head movements to the left or to the right, compared to the cardioid pattern; therefore, the bidirectional pattern should not be used at low gain conditions when the system is sufficiently far away from feedback.

Preferably, the audio signals captured by the microphone arrangement are transmitted via a wireless link in order to enable free movement of the speaker.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a schematic block diagram of a speech enhancement system according to the invention;

FIG. 2 is a more detailed block diagram of an example of a speech enhancement system according to the invention; and

FIG. 3 is a block diagram of an example of a wireless speech enhancement system according to the invention.

### DETAILED DESCRIPTION OF THE INVENTION

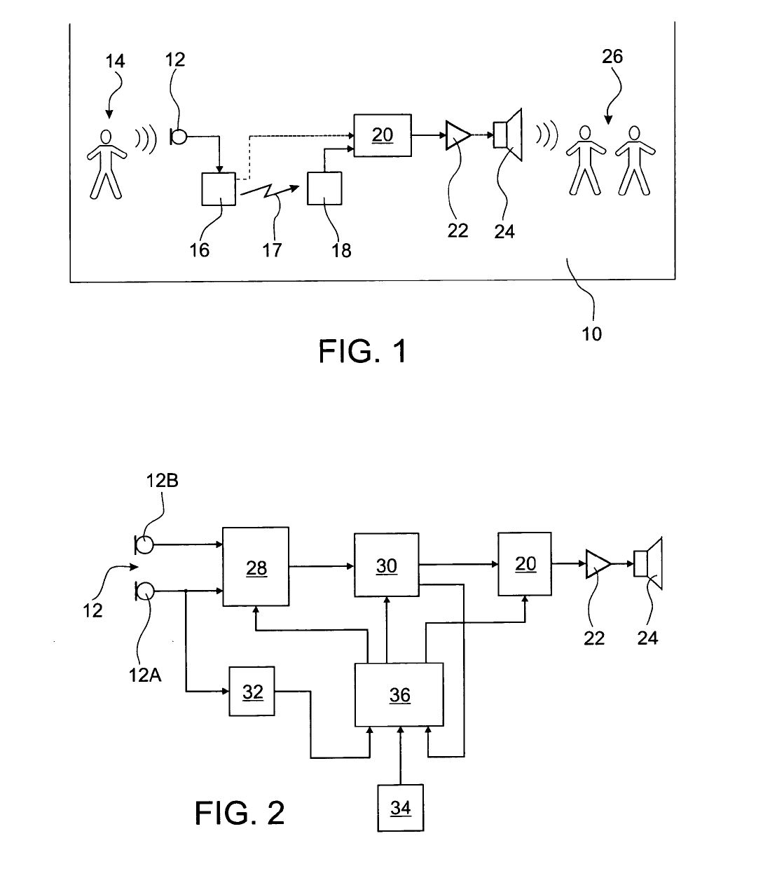

FIG. 1 is a schematic representation of a system for enhancement of speech in a room 10. The system comprises a microphone arrangement 12 for capturing audio signals from the voice of a speaker 14, The microphone arrangement 12 comprises at least two spaced apart acoustic sensors/microphones 12A, 12B (see FIG. 2) for achieving a directional pattern of the acoustic sensitivity. The audio signals are supplied to a unit 16 which may provide for pre-amplification of the audio signals and which, in case of a wireless microphone arrangement, includes a transmitter or transceiver for establishing a wireless audio link 17, such as an analog FM link or, preferably, a digital link. The audio signals are supplied, either by wire or, in case of a wireless microphone arrangement, via an audio signal receiver 18 to an audio signal processing unit 20 for processing the audio signals, in particular in order to apply a spectral filtering and gain control to the audio signals (alternatively, such audio signal processing, or at least part thereof, could take in the unit 16). The processed audio signals are supplied to a power amplifier 22 operating at constant gain or at an adaptive gain (preferably dependent on the ambient noise level) in order to supply amplified audio signals to a loudspeaker arrangement 24 in order to generate amplified sound according to the processed audio signals, which sound is perceived by listeners 26.

A more detailed example of such a system is shown in FIG. 2, wherein the microphone arrangement 12 consists of two spaced apart microphones 12A and 12B which capture audio signals which are supplied to a beamformer unit 28 for processing the audio signals in a manner so as to impart a certain directional pattern to the microphone arrangement 12. According to the invention, the beamforming unit 28 is adapted to provide for at least two different directional patterns, wherein the presently applied directional pattern is selected according to the feedback status of the system, as will be explained later in more detail. The audio signals as processed by the beamformer unit 28 are supplied to a feedback cancellation unit 30 for applying a feedback cancellation algorithm to the audio signals in order to reduce feedback noise. The feedback cancellation unit 30 also provides for a feedback status signal which indicates how close the system to an acoustic feedback condition. The audio signals as processed by the feedback cancellation unit 30 are supplied to an audio signal processing unit 20 which applies spectral filtering and gain control to the audio signals. The audio signals as processed by the audio signal processing unit 20 are supplied to a power amplifier 22 and from there to a loudspeaker arrangement 24.

According to the invention, the selection of the directional pattern imparted by the beamformer unit 28 is controlled by the feedback status signal provided by the feedback cancellation unit 30. The feedback status signal also may serve to select a specific feedback cancellation algorithm in the feedback cancellation unit 30 according to the presently prevailing feedback status of the system.

Typically, the system also comprises an audio signal analyzer unit 32 for analyzing the audio signals as captured by the microphone arrangement 12. Such analyzer unit 32 may comprise a voice activity detector (VAD) for determining whether the user of the microphone arrangement 12 is presently speaking and an ambient noise level estimator for estimating the ambient voice level. The output signals of the analyzer unit 32 may be used for controlling the audio signal processing in the audio signal processing unit 20, for example by adjusting the gain and/or the spectral filtering according to the information provided by the analyzer unit 32. Typically, the system also comprises a user interface 34 for allowing the users of the system to provide for individual adjustment of the system, such as for adjustment of the desired gain.

Typically, the system comprises a controller 36 for controlling operation of the system. In particular, the controller 36 may receive the output signal of the analyzer unit 32, the user interface 34 and the feedback status signal from the feedback cancellation unit 30 in order to control operation of the beam former unit 28, the feedback cancellation unit 30 and the audio signal processing unit 20 accordingly.

Preferably, the microphone arrangement is a lapel microphone arrangement, and the microphones 12A, 12A preferably are of an omni-directional type. Typically the microphone arrangement 12 will be arranged in such a manner that the imaginary line connecting the two microphones 12A, 12B is oriented substantially vertically, i.e. the microphone arrangement 12 is fixed at the speaker's cloth accordingly. The feedback status signal may be provided by the feedback cancellation unit 30 by estimating the gain of the feedback loop (which in the example of FIG. 2 is formed by the microphone arrangement 12, the electronic component processing the audio signals, such as the units 28, 30, 20, the power amplifier 22 and the loudspeaker arrangement 24).

For example, the feedback status signal may have a first value when the estimated gain of the feedback loop is at or above a predetermined total gain threshold value, with this first value indicating that the system is close to feedback, and a second value when the estimated gain of the feedback loop is below said total gain threshold value, with this second value indicating that the system is not critically close to feedback (feedback is reached when the gain of the feedback loop is unity (“Larsen condition”)). The gain of the feedback loop depends on the specific circumstances under which the system is used, such as the manual gain adjustment, the acoustic conditions in the room in which the system is used, the position and orientation of the microphone arrangement 12 and of the loudspeaker arrangement 24, etc. A first directional pattern is selected for audio signal processing the beamformer unit 28 when the feedback status signal has the first value and a second directional pattern is selected when the feedback status signal has the second value.

Typically, the loudspeaker arrangement 24 is formed by an array of loudspeakers which is placed at or close to a wall of the room. Preferably the ratio of the sensitivity for sound impinging in a horizontal plane onto the microphone arrangement 12 and the sensitivity for sound impinging in a vertical direction onto the microphone arrangement 12 is lower for the second direction pattern than for the first directional pattern. in order to reduce pick-up of sound from the loudspeaker arrangement 24 when the system is close to feedback.

Preferably, the first directional pattern is a cardioid pattern, wherein the direction of the highest sensitivity is oriented substantially towards the mouth of the speaker 14. The second directional pattern preferably is a bidirectional pattern (also called a “figure 8 pattern”), wherein the direction of the highest sensitivity is oriented substantially towards the mouth of the speaker. Thus, the second directional pattern, which is selected when the system is close to feedback, has a reduced sensitivity to the sound generated by the loudspeaker arrangement 24 (which sound typically has a directional pattern with high contributions in a horizontal plane), whereby the total gain in the feedback loop is reduced, since the microphone arrangement 12, when operated with a bidirectional pattern, picks up less sound from the loudspeaker arrangement 24, thereby enhancing stability against feedback.

It is to be understood that, depending on the specific design of the system, other directional patterns may be utilized.

As already mentioned above, the respective directional pattern of the microphone arrangement 12 is created by the beamformer unit 28 by accordingly processing the audio signal input from the microphones 12A, 12B. For example, a cardioid pattern may be created by a simply delay-and-sum design of the beam former unit 28 (i.e. one of the two microphone signals is delayed before the two signals are combined). A bidirectional pattern may be created, for example, by simply subtracting the signals of the two microphones 12A, 12B (i.e. by adding after multiplying one of the signals by −1, with no delay being applied). More advanced techniques for beamforming may involve, for example, spatial frequency or the concept of virtual microphones, see e.g., “Robust phase shift estimation in noise for microphone arrays with virtual sensors” by M. Arcienega, A. Drygajlo, and J. Maisano, at http://www.eurasip.org/Proceedings/Eusipco/Eusipco2000/sessions/ThuAm/PO1/cr1355.pdf. Overviews regarding acoustic beamforming concepts are found, for example, in “Microphone Arrays: A Tutorial” by I. McCowan, at http://www.idiap.ch/˜mccowan/arrays/tutorial.pdf, (see also, “Robust Speech Recognition using Microphone Arrays”, by I. McCowan, PhD Thesis, Queensland University of Technology, Australia 2001) and “Microphone Arrays”, M. Brandstein and D. ward (Eds.), Springer, 2001.

Preferably, the selection of the directional pattern imparted by the beam former unit 28 employs some hysteresis, i.e. the value of the feedback status signal at which the beam former unit 28 switches from one directional pattern to the other depends on the direction of the switching, i.e. the threshold values may be different depending on whether the system switches from the first pattern to the second pattern (i.e., when the feedback loop is found to increase) or whether the beam forming unit 28 switches from the second pattern to the first pattern (i.e. when the gain in the feedback loop is found to decrease).

As already mentioned above, the feedback cancellation unit 30 may apply different feedback cancellation algorithms as a function of the estimated gain in the feedback loop. For example, a time domain feedback cancellation algorithm may be selected when the gain in feedback loop is below a certain threshold value, and a frequency domain feedback cancellation algorithm may be selected when the gain in the feedback loop is at or above that threshold value. The advantage of time domain feedback cancellation is that there is no delay of the audio signals due to the signal processing in the frequency domain. However, since frequency domain feedback cancellation tends to be more efficient, frequency domain feedback cancellation is preferably employed at high gain in the feedback loop. Typically, the selection-switching will employ some kind of hysteresis, for example 3 dB with regard to the estimated gain in the feedback loop. The frequency domain feedback cancellation algorithm may apply a Wiener filter to the audio signals. In particular, the frequency domain feedback cancellation algorithm may estimate the transfer function of the feedback loop and apply a filter corresponding to the inverse estimated transfer function to the audio signals in order to eliminate the signal parts caused by feedback. Of course, also other feedback cancellation algorithms may be used, as it is known in the art.

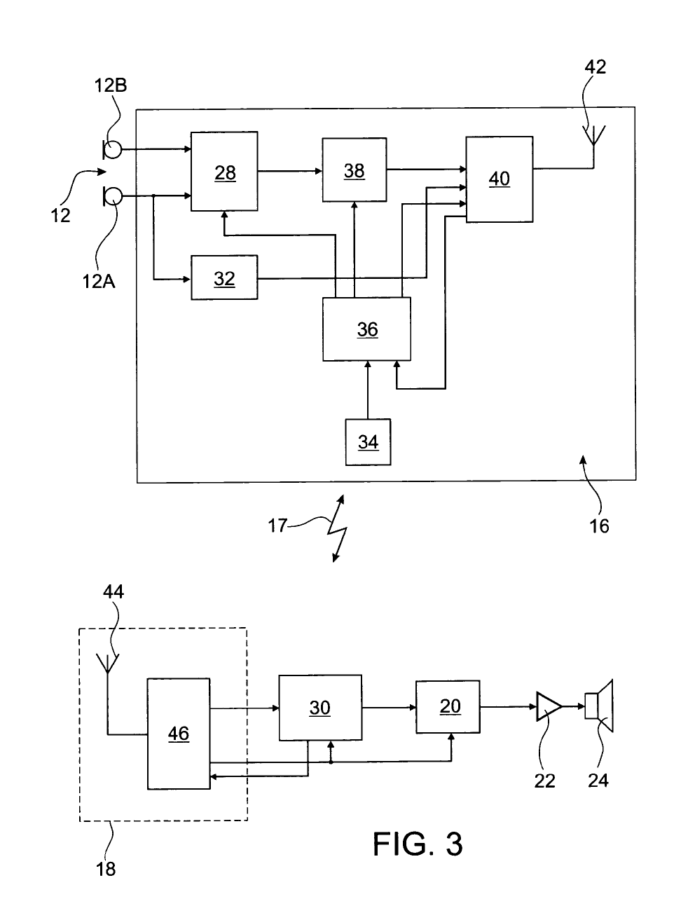

In FIG. 3, a block diagram of a wireless speech enhancement system is shown, wherein the microphone arrangement 12 is connected to a transmission unit 16 comprising a beamformer unit 28, an audio signal analyzer unit 32, a user interface 34 and a controller 36, with these elements having the same functionality as in the system shown in FIG. 2. In addition, the transmission unit 16 comprises a gain model unit 38, a digital transceiver 40 and an antenna 42. The audio signals as processed by the beamformer unit 28 are supplied to the gain model unit 38 in order to apply a suitable gain model to the audio signals (typically a gain model wherein the gain is reduced at low and high input levels relative to medium input levels). The output of the gain model unit 38 is supplied to the digital transceiver for sending the audio signals via the digital link 17 to a receiver unit 18. In addition, also the output of the analyzer unit 32 and an output of the controller 36 concerning commands/data received from the user interface 34 are supplied to the transceiver 40 in order to transmit corresponding data/commands to the receiver unit 18.

The receiver unit 18 comprises an antenna 44 and a transceiver 46 for receiving the audio signals and other data and commands transmitted from the transmission unit 16 via the link 17. The received audio signals are supplied to a feedback cancellation unit 30 which corresponds to the feedback cancellation unit 30 of the system of FIG. 2. The feedback status signal provided by the feedback cancellation unit 30 is supplied to the transceiver 46 in order to transmit the feedback status signal to the transceiver 40 of the transmission unit 16, from where the feedback status signal is supplied to the controller 36 in order to use it for controlling the beamformer unit 28. The output of the feedback cancellation unit 30 is supplied to an audio signal processing unit 20, from where the audio signals are supplied via a power amplifier 22 to a loudspeaker arrangement 24, with these elements corresponding to the respective elements of the system of FIG. 2. The data and commands resulting from the analyzer unit 32 and controller 36 as received via the link 17 are supplied from the transceiver 46 to the feedback cancellation unit 30 and the audio signal processing unit 20.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1-23. (canceled)

24. A system for speech enhancement in a room, comprising:
a microphone arrangement comprising at least two spaced apart microphones for capturing audio signals from a speaker's voice,
an acoustic beamforming unit for processing the captured audio signals in a manner so as to impart one of a plurality of different directional patterns to the microphone arrangement;
a feedback cancellation unit for applying a feedback cancellation algorithm to the processed audio signals and for providing a feedback status signal indicating how close an acoustic feedback loop of the system is to feedback;
means for amplifying the processed audio signals;
a loudspeaker arrangement to be located in the room for generating sound according to the amplified audio signals; and
means for selecting the directional pattern imparted to the microphone arrangement as a function of the feedback status signal.

25. The system of claim 24, wherein the microphone arrangement is a lapel microphone arrangement.

26. The system of claim 24, wherein the microphones of the microphone arrangement are of an omnidirectional type.

27. The system of claim 24, wherein the beamforming unit is of a delay-and-sum-type.

28. The system of claim 24, wherein the microphone arrangement forms part of or is connected to a transmission unit for transmitting audio signals via a wireless link to a receiver unit forming part of or being connected to the loudspeaker arrangement.

29. The system of claim 28, wherein the beamformer unit forms part of the transmission unit and the feedback cancellation unit forms part of the receiver unit, wherein the receiver unit comprises means for transmitting the feedback status signal via the wireless link to the transmission unit.

30. The system of claim 24, wherein the selection of the directional pattern to be imparted to the microphone arrangement employs a hysteresis.

31. The system of claim 24, wherein the feedback status signal has a first value indicating that the system is critically close to the feedback condition and a second value indicating that the system is not critically close to the feedback condition, wherein a first directional pattern is selected when the feedback status signal has the first value and a second directional pattern is selected when the feedback status signal has the second value.

32. The system of claim 24, wherein the feedback status signal is provided by estimating the gain of the feedback loop of the system.

33. The system of claim 32, wherein the feedback status signal is provided by estimating the gain of the feedback loop of the system, and wherein the feedback status signal has the first value when the estimated gain of the feedback loop of the system is at or above a predetermined gain threshold value and wherein the feedback status has the second value when the estimated gain of the feedback loop of the system is below said gain threshold value.

34. The system of claim 31, wherein the ratio of a sensitivity for sound impinging in a horizontal plane onto the microphone arrangement and a sensitivity for sound impinging in a vertical direction onto the microphone arrangement is lower for the second directional pattern than for the first directional pattern.

35. The system of claim 34, wherein the first directional pattern is a cardioid pattern.

36. The system of claim 35, wherein the direction of a highest sensitivity of the cardioid pattern is oriented substantially towards a mouth of the speaker.

37. The system of claim 34, wherein the second directional pattern is a bidirectional pattern.

38. The system of claim 37, wherein the direction of the highest sensitivity of the bidirectional pattern is oriented substantially towards the mouth of the speaker.

39. The system of claim 24, wherein the microphone arrangement is arranged such that an imaginary line connecting the two microphones of the microphone arrangement is oriented substantially vertically.

40. The system of claim 24, wherein a feedback cancellation algorithm is selected from a plurality of feedback cancellation algorithms as a function of the feedback status signal.

41. The system of claim 40, wherein a time domain feedback cancellation algorithm is selected when the estimated gain of the feedback loop of the system is below a threshold value and a frequency domain feedback cancellation algorithm is selected when an estimated gain of the feedback loop of the system is at or above said threshold value.

42. The system of claim 41, wherein the frequency domain feedback cancellation algorithm applies a Wiener filter to the audio signals.

43. The system of claim 41, wherein the frequency domain feedback cancellation algorithm estimates a transfer function of the feedback loop of the system and applies a filter corresponding to an inverse estimated transfer function to the audio signals in order to eliminate signal parts caused by feedback.

44. The system of claim 40, wherein the selection of the feedback cancellation algorithm employs a hysteresis.

45. The system of claim 24, wherein the loudspeaker arrangement is positioned at or close to a wall of the room.

46. A method of speech enhancement in a room, comprising:
capturing audio signals from a speaker's voice by a microphone arrangement comprising at least two spaced apart microphones;
applying acoustic beamforming processing to the captured audio signals in a manner so as to impart one of a plurality of different directional patterns to the microphone arrangement;
applying a feedback cancellation algorithm to the processed audio signals;
generating sound according to the processed audio signals by a loudspeaker arrangement;
providing a feedback status signal indicating how close an acoustic feedback loop of the system to feedback; and
selecting the directional pattern imparted to the microphone arrangement as a function of the feedback status signal.
